(19) United States
(12) Patent Application Publication
(10) Pub. No.: US 2013/0268541 A1
(43) Pub. Date: Oct. 10, 2013

(54) Learning Measurement and Analyzer Method

(71) Applicant: Praful Chitnis, Iowa City, IA (US)

(72) Inventor: Praful Chitnis, Iowa City, IA (US)

(73) Assignee: Praful Chitnis, Iowa City, IA (US)

(21) Appl. No.: 13/442,770

(22) Filed: Apr. 9, 2012

(51) Int. Cl. G06F 17/30

(52) U.S. Cl. 707/748; 707/E17.033

(57) ABSTRACT

A method for measuring the student learning by utilizing accuracy of a response, time taken to respond and utilization of help feature on a website. The website presents to the students a range of predefined set of questions that are associated with a concept being learned by the student and is the subject of learning measurement. The student has an option of utilizing one or more help features before answering. The method utilizes monitoring the accuracy, time taken to respond and the help features utilized to generate a score for student and provides a set of analytics to teacher/course administrator to measure the student learning as well as effectiveness of the content.

### BACKGROUND OF THE INVENTION

1. Field of the Invention

The invention relates to a web site that allows for presentation of a set of questions along with a set of help features to students and then records their interactions for accuracy, response time and help usage to measure learning of the course content. The system also provides an analyzer to help teachers/course administrators to measure the effectiveness of course content based on the student interactions.

2. Description of the Related Technology

The use of business intelligence and data analytics concepts has exploded in the past decade, mainly for the financial analysis. This technology allows for identification of effective processes and helps make investments more effective. Use of this technology still lacks significantly in other areas, specifically , in the learning environments. Children today learn to use computers before they ride bicycles. The process of learning, just like bicycle riding , involves many falls and a need for training wheels. Heretofore, there has not been an effective and reliable mechanism to measure the student interactions on dimensions other than that of accuracy. Most solutions simply use accuracy as a measure.

Many commercial organizations use computer based training and courses. This is a very cost effective approach, but lacks the interactions with the teachers and therefore, makes it difficult for the course administrators/teachers to really measure the effectiveness of course content and student learning. The use of business intelligence tools along with the proper set of data, allows the course administrators/teachers to analyze the student interactions to improve the course content and to adjust their teaching methods and time allotted to each concept. Concepts that students have struggled with can be reviewed before the next topic is introduced in the next session. This approach brings a level of insight that is lacking in current systems. Students also gain a better understanding of their mastery of topics based on the same set of data.

### SUMMARY OF THE INVENTION

It is an object of the invention to record student responses to a set of questions along multiple dimensions including, but not limited to, accuracy, response time and help feature usage.

It is a further object of the invention to facilitate measurement of learning along multiple dimensions including, but not limited to, accuracy, response time and help usage as a combined multi-dimensional measurement.

It is a further object of the invention to allow teacher/course administrator to generate an overall score by using a combination of the measurements and be able to define the rules to generate this score.

It is a further object of the invention to allow teachers/course administrators to be able to analyze the effectiveness of the help features and other measurements by recording and analyzing the effect of these on accuracy of the result, and therefore learning effectiveness.

It is a further object of the invention to allow students to be able to measure their own mastery of topics using a multi-dimensional criteria i.e. based on accuracy, response time and help feature usage.

According to the invention, a system may be provided to record multiple interactions attributes for student interactions as part of presentation of questions. This will allow teachers to gain a deeper insight into—

What concepts students are struggling with?

Where students need some help to get started?

Are students finally learning the concepts after using the help features?

Are there distinct groups of students, based on learning?

Questions like these can be answered by teachers and then acted upon to improve the course content.

According to the invention, the learning process need not be measured by just the right/wrong responses of the students. The learning process has many elements to it and this system enables teachers/course administrators to start using technology to measure those elements and provide more effective content online. For example—

a topic where most of the student used help feature and got answers right has an effective set of help features but may need a quick review in next class/lecture.

a topic where most of the students used help features but did not answer correctly does not have an effective set of help features.

average time spent by students allows the teacher to adjust assignment length.

According to the invention, the students will be able to analyze their own learning along multiple dimensions and will have a better understanding of what content to work more on by reviewing their accuracy, time and help usage as a combination, rather than just relying on a score based on right or wrong answers. For example—

a student who gets all questions right without using help feature

a student who gets all questions right while using help features

a student who gets all questions right while using help features but uses multiple help features and takes longer

All the three students above would score the same on the right/wrong measurement but are at a different mastery level. This system will provide with feedback that allows students to focus their energies on learning the concepts that they have not mastered while allowing teachers to build better content for web based learning.

According to the invention, the effectiveness of content can be measured using recorded data along multiple dimensions to support the proliferation of options available today e.g. documents, video, social media sharing and collaboration etc.

In addition, it is further a object of the invention to provide a set of “housekeeping” utility functions to support creation of a bank of questions associated with a topic and having a set of help features to be used in the building of assignments to support the measurement and analysis capability. The data bank may be extended to contain additional attributes for the questions to further relate them to the three primary measurement criteria of accuracy, response time and help feature usage. An example of this would be the complexity level of the question. A more complex question may result in a higher level of help usage and this invention will support a measurement for relating the question complexity to the help usage as well.

### BRIEF DESCRIPTION OF THE DRAWINGS

FIG. 1—Shows the flow diagram for the invention

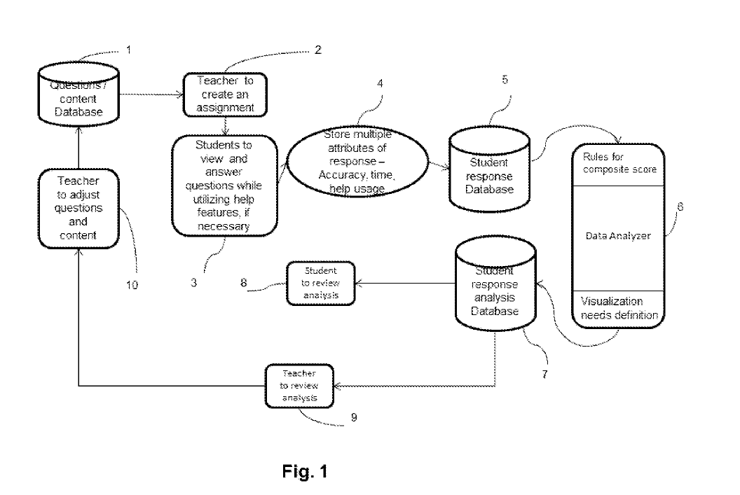

FIG. 2—Data Analyzer function

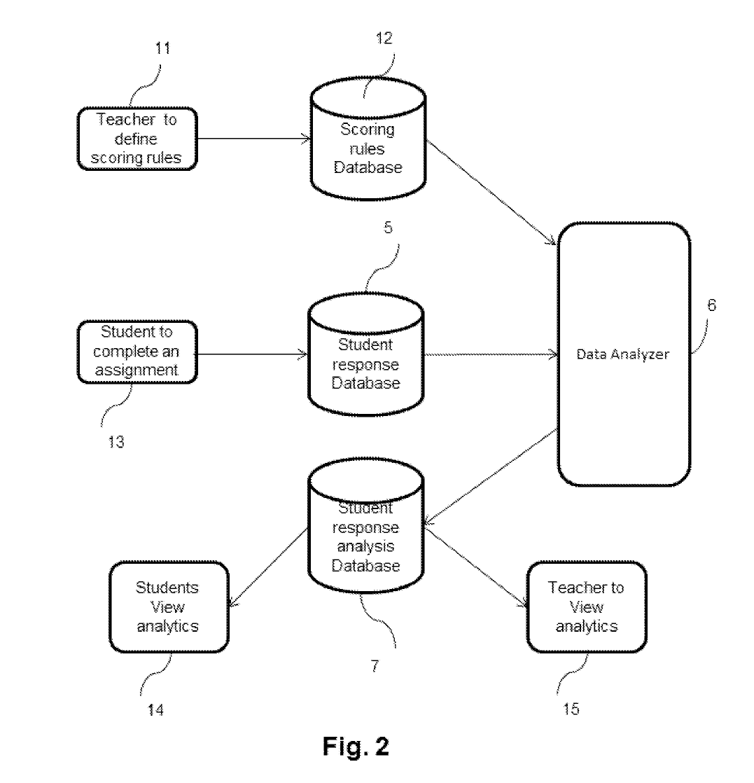

FIG. 3—The concept of a combined score along multiple dimensions

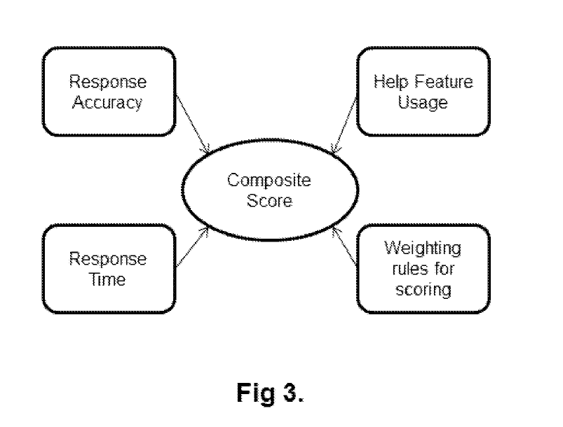

1. A web site that allows a teacher/course administrator to present a set of questions along with a range of progressive help features to a plurality of students and generates a composite score based on the accuracy of response, time taken and use of help features provided.

2. The method according to claim 1, records the student interactions on three criteria—accuracy, response time and the use of help features.

3. The method according to claim 1, provides teachers an ability to view student responses based on accuracy (% correct/% incorrect OR by individual students) and use of help features to analyze effectiveness/utility of help features.

4. The method according to claim 1, provides a teacher/course administrator to generate an assignment/test using a set of questions with progressive help features and ability to record usage and effectiveness of help features

5. The method according to claim 1, provides a teacher/course administrator a set of analytics to analyze student performances along the accuracy, duration, help usage, student and course topic dimensions.

6. The method according to claim 1, provides teacher/course administrator an ability to provide weighting to response accuracy, response time and help feature usage to generate a composite score for students that is not just based on response accuracy (right/wrong).

7. The method according to claim 1, provides students an ability to identify gaps in their knowledge using a combination of course topic, accuracy, response time and help usage information.

8. The method according to claim 1, provides data for trend analysis utilizing a star schema with dimensions of course topics, accuracy, response time and help feature usage.

9. The method according to claim 1, provides teacher/course administrator an ability to extend the data model by associating additional attributes and then analyze them along the dimensions of accuracy, response time, help usage, course topic and student.
